(19) United States
(12) Patent Application Publication
(10) Pub. No.: US 2020/0083516 A1
(43) Pub. Date: Mar. 12, 2020

(54) PRODUCTION METHOD FOR THIN FILM CONTAINING CONDUCTIVE CARBON MATERIAL

(71) Applicant: NISSAN CHEMICAL CORPORATION, Tokyo (JP)

(72) Inventors: Tatsuya HATANAKA, Funabashi-shi, Chiba (JP); Yuki SHIBANO, Funabashi-shi, Chiba (JP); Takuji YOSHIMOTO, Funabashi-shi, Chiba (JP)

(73) Assignee: NISSAN CHEMICAL CORPORATION, Tokyo (JP)

(21) Appl. No.: 16/465,941

(22) PCT Filed: Nov. 29, 2017
(86) PCT No.: PCT/JP2017/042740

§ 371 Date: May 31, 2019

(30) Foreign Application Priority Data
Dec. 2, 2016 (JP) 2016-235088

(51) Int. Cl. H01M 4/04; B05D 1/30; B05D 1/26; H01M 4/66; H01G 11/86; H01G 11/36; H01G 11/28; C09D 5/24; C09D 7/40; C09D 7/45; C09D 7/65

(52) U.S. Cl. CPC H01M 4/0402; B05D 1/305; B05D 1/265; H01M 4/663; H01G 11/86; C09D 7/65; H01G 11/28; C09D 5/24; C09D 7/70; C09D 7/45; H01G 11/36

(57) ABSTRACT

Provided is a production method for a thin film containing a conductive carbon material, the method being characterized by including a step for applying a coating liquid which contains a conductive carbon material such as carbon nanotubes using a gravure coater or a die coater.

### TECHNICAL FIELD

The present invention relates to a method for producing a thin film containing an electrically conductive carbon material.

### BACKGROUND ART

There has been a desire in recent years to increase the capacity and the rate of charge and discharge of energy storage devices such as lithium-ion secondary batteries and electrical double-layer capacitors in order to accommodate their use in, for example, electric vehicles and electrically powered equipment.

One way to address this desire has been to place an undercoat layer between an active material layer and a current-collecting substrate, thereby strengthening adhesion between the active material layer and the current-collecting substrate and also lowering the resistance at the contact interface therebetween (see, for example, Patent Documents 1 and 2).

An undercoat layer is generally formed by applying onto a substrate a coating liquid obtained by uniformly dispersing a conductive carbon material such as carbon black in a given dispersant. When the weight per unit surface area (coating weight) at this time is large, the battery becomes heavier; at the same time, the battery becomes larger, due in part to an increase in thickness. This problem is even greater in cases where a plurality of electrode plates are stacked and used together to achieve a higher device capacity.

In recent years, there has been a desire to reduce the size and weight of energy storage devices without lowering their performance. In order to address this desire, the undercoat layer must be formed more thinly.

To further reduce the thickness of the undercoat layer, it is necessary that the concentration of conductive carbon material in the coating liquid be made lower.

However, in conventional conductive carbon material-containing coating liquids, owing to the large difference in specific gravity between the conductive material and the dispersant and to the tendency for the conductive carbon material to precipitate, the concentration rises, making the liquid highly viscous at the time of use and thus unsuitable for high-speed application.

### PRIOR ART DOCUMENTS

### Patent Documents

Patent Document 1: JP-A 2010-170965

Patent Document 2: WO 2014/042080

### SUMMARY OF INVENTION

### Technical Problem

The present invention was arrived at in light of the above circumstances. An object of the invention is to provide a method for producing a conductive carbon material-containing thin film by using a gravure coater or a die coater to apply a conductive carbon material-containing coating liquid onto a substrate and thus render the coating liquid into a thin film.

### Solution to Problem

The inventors have conducted extensive investigations aimed at resolving the above problems. As a result, they have discovered a carbon material-containing coating liquid that can be applied as a thin film using a gravure coater or a die coater, ultimately arriving at the present invention.

Accordingly, the invention provides:

1. A method for producing a conductive carbon material-containing thin film, which method includes the step of applying a conductive carbon material-containing coating liquid using a gravure coater or a die coater;
2. The conductive carbon material-containing thin film-producing method of 1 above, wherein the thin film has a coating weight of not more than 1,000 mg/m²;
3. The conductive carbon material-containing thin film-producing method of 2 above, wherein the thin film has a coating weight of not more than 250 mg/m²;
4. The conductive carbon material-containing thin film-producing method of any of 1 to 3 above, wherein the conductive carbon material is carbon nanotubes;
5. The conductive carbon material-containing thin film-producing method of any of 1 to 4 above, wherein the conductive carbon material-containing coating liquid has a solids concentration of not more than 40.0 wt %;
6. The conductive carbon material-containing thin film-producing method of 5 above, wherein the conductive carbon material-containing coating liquid has a solids concentration of not more than 20.0 wt %;
7. The conductive carbon material-containing thin film-producing method of 6 above, wherein the conductive carbon material-containing coating liquid has a solids concentration of not more than 10.0 wt %;
8. The conductive carbon material-containing thin film-producing method of 7 above, wherein the conductive carbon material-containing coating liquid has a solids concentration of not more than 5.0 wt %;
9. The conductive carbon material-containing thin film-producing method of 8 above, wherein the conductive carbon material-containing coating liquid has a solids concentration of not more than 2.0 wt %;
10. The conductive carbon material-containing thin film-producing method of any of 1 to 9 above, wherein application is carried out using a gravure coater;
11. The conductive carbon material-containing thin film-producing method of any of 1 to 10 above, wherein the conductive carbon material-containing coating liquid includes a dispersant which is a triarylamine-based highly branched polymer or a pendant oxazoline group-containing vinyl polymer; and
12. The conductive carbon material-containing thin film-producing method of any of 1 to 11 above, wherein the conductive carbon material-containing thin film is an undercoat foil for an energy storage device electrode.

### Advantageous Effects of Invention

This invention makes it possible to produce a conductive carbon material-containing thin film by applying a conductive carbon material-containing coating liquid using a gravure coater or a die coater, enabling energy storage devices to be made even smaller and thinner.

### BRIEF DESCRIPTION OF DRAWINGS

FIG. 1 is an electron micrograph taken of the undercoat layer formed in Example 14.

### DESCRIPTION OF EMBODIMENTS

The present invention is described more fully below.

The method for producing a conductive carbon material-containing thin film according to the present invention is characterized by including the step of applying a conductive carbon material-containing coating liquid using a gravure coater or a die coater.

The gravure coater and die coater used are not particularly limited, and may be suitably selected from among known coaters. However, from the standpoint of uniformly producing thin films, a gravure coater is especially preferred.

The coating liquid has a solids concentration which, in order to make the thin film thickness even smaller (the coating weight even lower), is preferably not more than 40.0 wt %, more preferably not more than 20.0 wt %, even more preferably not more than 10.0 wt %, still more preferably not more than 5.0 wt %, and yet more preferably not more than 2.0 wt %. The solids concentration here signifies the total weight of the ingredients other than the solvent which are included in the coating liquid.

Also, the coating liquid has a viscosity, as measured with a type E viscometer at 25° C., which, although not particularly limited, is preferably not more than 500 cp, more preferably not more than 250 cp, even more preferably not more than 100 cp, still more preferably not more than 75 cp, and yet more preferably not more than 30 cp.

The conductive carbon material used in the conductive carbon material-containing coating liquid of the invention is not particularly limited, and may be suitably selected from among known conductive carbon materials such as carbon black, ketjen black, acetylene black, carbon whiskers, carbon nanotubes (CNTs), carbon fibers, natural graphite and synthetic graphite. However, because it has a high specific surface area and, with the use of the subsequently described dispersant, can be stably dispersed at a low concentration, the use of a CNT-containing conductive carbon material is more preferred, and the use of a conductive carbon material consisting solely of CNTs is still more preferred.

Carbon nanotubes are generally produced by an arc discharge process, chemical vapor deposition (CVD), laser ablation or the like. The CNTs used in this invention may be obtained by any of these methods. CNTs are categorized as single-walled CNTs consisting of a single cylindrically rolled graphene sheet (abbreviated below as “SWCNTs”), double-walled CNTs consisting of two concentrically rolled graphene sheets (abbreviated below as “DWCNTs”), and multi-walled CNTs consisting of a plurality of concentrically rolled graphite sheets (MWCNTs). SWCNTs, DWCNTs or MWCNTs may be used alone in the invention, or a plurality of these types of CNTs may be used in combination.

When SWCNTs, DWCNTs or MWCNTs are produced by the above methods, catalyst metals such as nickel, iron, cobalt or yttrium may remain in the product, and so purification to remove these impurities is sometimes necessary. Acid treatment with nitric acid, sulfuric acid or the like and ultrasonic treatment are effective for the removal of impurities. However, in acid treatment with nitric acid, sulfuric acid or the like, there is a possibility of the π-conjugated system making up the CNTs being destroyed and the properties inherent to the CNTs being lost. It is thus desirable for the CNTs to be purified and used under suitable conditions.

Specific examples of CNTs that may be used in the invention include CNTs synthesized by the super growth method (available from the New Energy and Industrial Technology Development Organization (NEDO) in the National Research and Development Agency), eDIPS-CNTs (available from NEDO in the National Research and Development Agency), the SWNT series (available under this trade name from Meijo Nano Carbon), the VGCF series (available under this trade name from Showa Denko KK), the FloTube series (available under this trade name from CNano Technology), AMC (available under this trade name from Ube Industries, Ltd.), the NANOCYL NC7000 series (available under this trade name from Nanocyl S.A.), Baytubes (available under this trade name from Bayer), GRAPHISTRENGTH (available under this trade name from Arkema), MWNT7 (available under this trade name from Hodogaya Chemical Co., Ltd.) and Hyperion CNT (available under this trade name from Hyperion Catalysis International).

The dispersant used is not particularly limited and may be suitably selected from among known dispersants. Illustrative examples include polysaccharides such as carboxymethylcellulose (CMC), heterocyclic polymers such as polyvinylpyrrolidone (PVP), water-soluble olefin polymers such as polyvinyl alcohol and polyvinyl acetal, sulfonic acid group-containing polymers such as polystyrene sulfonic acid and Nafion, acrylic polymers such as polyacrylic acid, acrylic resin emulsions, water-soluble acrylic polymers, styrene emulsions, silicone emulsions, acrylic silicone emulsions, fluoropolymer emulsions, EVA emulsions, vinyl acetate emulsions, vinyl chloride emulsions, urethane resin emulsions, the triarylamine-based highly branched polymers mentioned in WO 2014/04280 and the pendant oxazoline group-containing vinyl polymers mentioned in WO 2015/029949. In this invention, the triarylamine-based highly branched polymers mentioned in WO 2014/04280 and the pendant oxazoline group-containing vinyl polymers mentioned in WO 2015/029949 are preferred.

Specifically, preferred use can be made of the highly branched polymers of formula (1) and (2) below obtained by the condensation polymerization of a triarylamine with an aldehyde and/or a ketone under acidic conditions.

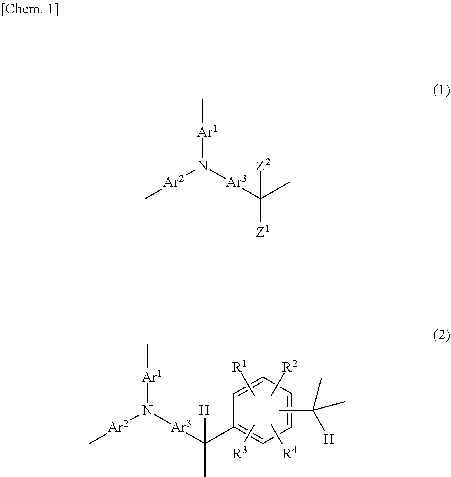

In formulas (1) and (2), Ar¹ to Ar³ are each independently a divalent organic group of any one of formulas (3) to (7), and are preferably a substituted or unsubstituted phenylene group of formula (3).

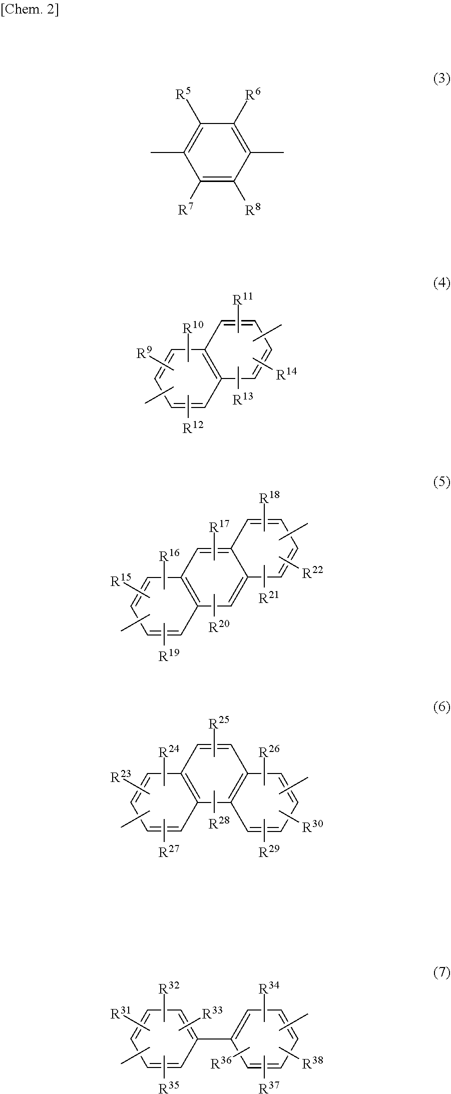

In these formulas, R⁵ to R³⁸ are each independently a hydrogen atom, a halogen atom, an alkyl group of 1 to 5 carbon atoms which may have a branched structure, an alkoxy group of 1 to 5 carbon atoms which may have a branched structure, a carboxyl group, a sulfo group, a phosphoric acid group, a phosphonic acid group, or a salt thereof.

In formulas (1) and (2), Z¹ and Z² are each independently a hydrogen atom, an alkyl group of 1 to 5 carbon atoms which may have a branched structure, or a monovalent organic group of any one of formulas (8) to (11) (provided that Z¹ and Z² are not both alkyl groups), with Z¹ and Z² preferably being each independently a hydrogen atom, a 2- or 3-thienyl group or a group of formula (8). It is especially preferable for one of Z¹ and Z² to be a hydrogen atom and for the other to be a hydrogen atom, a 2- or 3-thienyl group, or a group of formula (8), especially one in which R⁴¹ is a phenyl group or one in which R⁴¹ is a methoxy group.

In cases where R⁴¹ is a phenyl group, when the technique of inserting an acidic group following polymer production is used in the subsequently described acidic group insertion method, the acidic group is sometimes inserted onto this phenyl group.

Illustrative examples of alkyl groups of 1 to 5 carbon atoms which may have a branched structure include methyl, ethyl, n-propyl, isopropyl, n-butyl, sec-butyl, tert-butyl and n-pentyl groups.

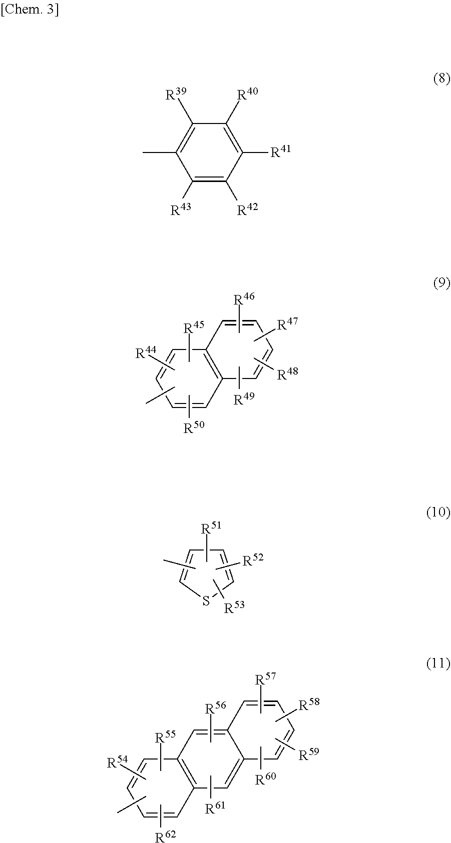

In these formulas, R³⁹ to R⁶² are each independently a hydrogen atom, a halogen atom, an alkyl group of 1 to 5 carbon atoms which may have a branched structure, a haloalkyl group of 1 to 5 carbon atoms which may have a branched structure, a phenyl group. OR⁶³, COR⁶³, NR⁶³R⁶⁴, COOR⁶⁵ (wherein R⁶³ and R⁶⁴ are each independently a hydrogen atom, an alkyl group of 1 to 5 carbon atoms which may have a branched structure, a haloalkyl group of 1 to 5 carbon atoms which may have a branched structure, or a phenyl group; and R⁶⁵ is an alkyl group of 1 to 5 carbon atoms which may have a branched structure, a haloalkyl group of 1 to 5 carbon atoms which may have a branched structure, or a phenyl group), a carboxyl group, a sulfo group, a phosphoric acid group, a phosphonic acid group, or a salt thereof.

In formulas (2) to (7), R¹ to R³⁸ are each independently a hydrogen atom, a halogen atom, an alkyl group of 1 to 5 carbon atoms which may have a branched structure, an alkoxy group of 1 to 5 carbon atoms which may have a branched structure, a carboxyl group, a sulfo group, a phosphoric acid group, a phosphonic acid group, or a salt thereof.

Here, examples of halogen atoms include fluorine, chlorine, bromine and iodine atoms.

The alkyl groups of 1 to 5 carbon atoms which may have a branched structure are exemplified in the same way as those mentioned above.

Illustrative examples of alkoxy group of 1 to 5 carbon atoms which may have a branched structure include methoxy, ethoxy, n-propoxy, isopropoxy, n-butoxy, sec-butoxy, tert-butoxy and n-pentoxy groups.

Exemplary salts of carboxyl groups, sulfo groups, phosphoric acid groups and phosphonic acid groups include sodium, potassium and other alkali metal salts; magnesium, calcium and other Group 2 metal salts, ammonium salts; propylamine, dimethylamine, triethylamine, ethylenediamine and other aliphatic amine salts; imidazoline, piperazine, morpholine and other alicyclic amine salts; aniline, diphenylamine and other aromatic amine salts; and pyridinium salts.

In formulas (8) to (11) above, R³⁹ to R⁶² are each independently a hydrogen atom, a halogen atom, an alkyl group of 1 to 5 carbon atoms which may have a branched structure, a haloalkyl group of 1 to 5 carbon atoms which may have a branched structure, a phenyl group, OR⁶³, COR⁶³, NR⁶³R⁶⁴, COOR⁶⁵ (wherein R⁶³ and R⁶⁴ are each independently a hydrogen atom, an alkyl group of 1 to 5 carbon atoms which may have a branched structure, a haloalkyl group of 1 to 5 carbon atoms which may have a branched structure, or a phenyl group; and R⁶⁵ is an alkyl group of 1 to 5 carbon atoms which may have a branched structure, a haloalkyl group of 1 to 5 carbon atoms which may have a branched structure, or a phenyl group), a carboxyl group, a sulfo group, a phosphoric acid group, a phosphonic acid group, or a salt thereof.

Here, illustrative examples of the haloalkyl group of 1 to 5 carbon atoms which may have a branched structure include difluoromethyl, trifluoromethyl, bromodifluoromethyl, 2-chloroethyl, 2-bromoethyl, 1,1-difluoroethyl, 2,2,2-trifluoroethyl, 1,1,2,2-tetrafluoroethyl, 2-chloro-1,1,2-trifluoroethyl, pentafluoroethyl, 3-bromopropyl, 2,2,3,3-tetrafluoropropyl, 1,1,2,3,3,3-hexafluoropropyl, 1,1,1,3,3,3-hexafluoropropan-2-yl, 3-bromo-2-methylpropyl, 4-bromobutyl and perfluoropentyl groups.

The halogen atoms and the alkyl groups of 1 to 5 carbon atoms which may have a branched structure are exemplified in the same way as the groups represented by above formulas (2) to (7).

In particular, to further increase adherence to the current-collecting substrate, the highly branched polymer is preferably one having, on at least one aromatic ring in the recurring units of formula (1) or (2), at least one type of acidic group selected from among carboxyl, sulfo, phosphoric acid and phosphonic acid groups and salts thereof, and more preferably one having a sulfo group or a salt thereof.

Illustrative examples of aldehyde compounds that may be used to prepare the highly branched polymer include saturated aliphatic aldehydes such as formaldehyde, p-formaldehyde, acetaldehyde, propylaldehyde, butyraldehyde, isobutyraldehyde, valeraldehyde, caproaldehyde, 2-methylbutyraldehyde, hexylaldehyde, undecylaldehyde, 7-methoxy-3,7-dimethyloctylaldehyde, cyclohexanecarboxyaldehyde, 3-methyl-2-butyraldehyde, glyoxal, malonaldehyde, succinaldehyde, glutaraldehyde and adipinaldehyde; unsaturated aliphatic aldehydes such as acrolein and methacrolein; heterocyclic aldehydes such as furfural, pyridinealdehyde and thiophenealdehyde; aromatic aldehydes such as benzaldehyde, tolylaldehyde, trifluoromethylbenzaldehyde, phenylbenzaldehyde, salicylaldehyde, anisaldehyde, acetoxybenzaldehyde, terephthalaldehyde, acetylbenzaldehyde, formylbenzoic acid, methyl formylbenzoate, aminobenzaldehyde, N,N-dimethylaminobenzaldehyde, N,N-diphenylaminobenzaldehyde, naphthaldehyde, anthraldehyde and phenanthraldehyde; and aralkylaldehydes such as phenylacetaldehyde and 3-phenylpropionaldehyde. Of these, the use of aromatic aldehydes is preferred.

Ketone compounds that may be used to prepare the highly branched polymer are exemplified by alkyl aryl ketones and diaryl ketones. Illustrative examples include acetophenone propiophenone, diphenyl ketone, phenyl naphthyl ketone, dinaphthyl ketone, phenyl tolyl ketone and ditolyl ketone.

The highly branched polymer that may be used in the invention is obtained, as shown in Scheme 1 below, by the condensation polymerization of a triarylamine compound, such as one of formula (A) below that is capable of furnishing the aforementioned triarylamine skeleton, with an aldehyde compound and/or a ketone compound, such as one of formula (B) below, in the presence of an acid catalyst.

In cases where a difunctional compound (C) such as a phthalaldehyde (e.g., terephthalaldehyde) is used as the aldehyde compound, not only does the reaction shown in Scheme 1 arise, the reaction shown in Scheme 2 below also arises, giving a highly branched polymer having a crosslinked structure in which the two functional groups both contribute to the condensation reaction.

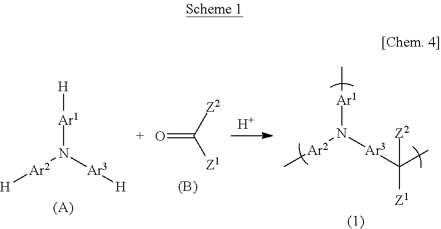

(wherein Ar¹ to Ar³ and both Z¹ and Z² are the same as defined above.)

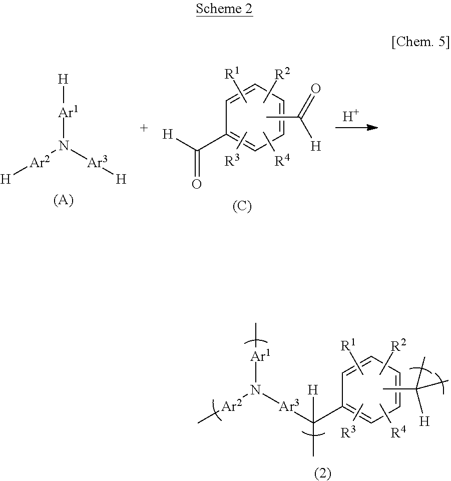

(wherein Ar¹ to Ar³ and R¹ to R⁴ are the same as defined above.)

In the condensation polymerization reaction, the aldehyde compound and/or ketone compound may be used in a ratio of from 0.1 to 10 equivalents per equivalent of aryl groups on the triarylamine compound.

The acid catalyst used may be, for example, a mineral acid such as sulfuric acid, phosphoric acid or perchloric acid; an organic sulfonic acid such as p-toluenesulfonic acid or p-toluenesulfonic acid monohydrate; or a carboxylic acid such as formic acid or oxalic acid.

The amount of acid catalyst used, although variously selected according to the type thereof, is generally from 0.001 to 10,000 parts by weight, preferably from 0.01 to 1,000 parts by weight, and more preferably from 0.1 to 100 parts by weight, per 100 parts by weight of the triarylamine.

The condensation reaction may be carried out without a solvent, although it is generally carried out using a solvent. Any solvent that does not hinder the reaction may be used for this purpose. Illustrative examples include cyclic ethers such as tetrahydrofuran and 1,4-dioxane; amides such as N,N-dimethylformamide (DMF), N,N-dimethylacetamide (DMAc) and N-methyl-2-pyrrolidone (NMP); ketones such as methyl isobutyl ketone and cyclohexanone; halogenated hydrocarbons such as methylene chloride, chloroform, 1,2-dichloroethane and chlorobenzene; and aromatic hydrocarbons such as benzene, toluene and xylene. Cyclic ethers are especially preferred. These solvents may be used singly, or two or more may be used in admixture.

If the acid catalyst used is a liquid compound such as formic acid, the acid catalyst may also fulfill the role of a solvent.

The reaction temperature during condensation is generally between 40° C. and 200° C. The reaction time may be variously selected according to the reaction temperature, but is generally from about 30 minutes to about 50 hours.

The weight-average molecular weight Mw of the polymer obtained as described above is generally from 1,000 to 2,000,000, and preferably from 2,000 to 1,000,000.

When acidic groups are introduced onto the highly branched polymer, this may be done by a method that involves first introducing the acidic groups onto aromatic rings of the above triarylamine compound, aldehyde compound and ketone compound serving as the polymer starting materials, then using this to synthesize the highly branched polymer; or by a method that involves treating the highly branched polymer following synthesis with a reagent that is capable of introducing acidic groups onto the aromatic rings. From the standpoint of the ease and simplicity of production, use of the latter approach is preferred.

In the latter approach, the technique used to introduce acidic groups onto the aromatic rings is not particularly limited, and may be suitably selected from among various known methods according to the type of acidic group.

For example, in cases where sulfo groups are introduced, use may be made of a method that involves sulfonation using an excess amount of sulfuric acid.

The average molecular weight of the highly branched polymer is not particularly limited, although the weight-average molecular weight is preferably from 1,000 to 2,000,000, and more preferably from 2,000 to 1,000,000.

The weight-average molecular weights in this invention are polystyrene-equivalent measured values obtained by gel permeation chromatography.

Specific examples of the highly branched polymer include, but are not limited to, those having the following formulas.

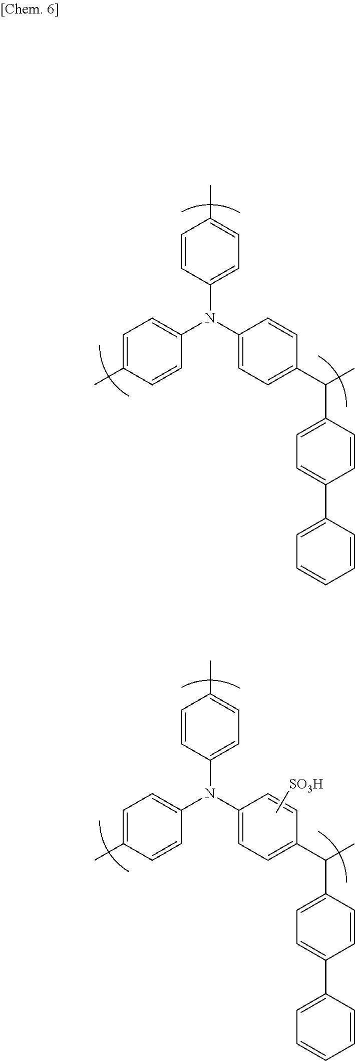

The pendant oxazoline group-containing vinyl polymer (referred to below as the “oxazoline polymer”) is preferably a polymer which is obtained by the radical polymerization of an oxazoline monomer of formula (12) having a polymerizable carbon-carbon double bond-containing group at the 2 position, and which has recurring units that are bonded at the 2 position of the oxazoline ring to the polymer backbone or to spacer groups.

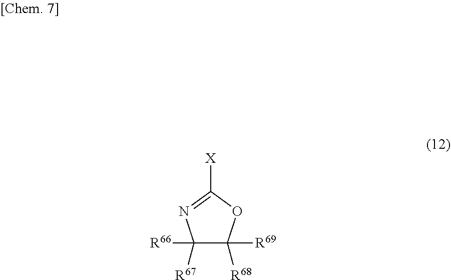

Here, X represents a polymerizable carbon-carbon double bond-containing group, and R⁶⁶ to R⁶⁹ are each independently a hydrogen atom, a halogen atom, an alkyl group of 1 to 5 carbon atoms, an aryl group of 6 to 20 carbon atoms, or an aralkyl group of 7 to 20 carbon atoms.

The polymerizable carbon-carbon double bond-containing group on the oxazoline monomer is not particularly limited, so long as it includes a polymerizable carbon-carbon double bond. However, an acyclic hydrocarbon group containing a polymerizable carbon-carbon double bond is preferable. For example, alkenyl groups having from 2 to 8 carbon atoms, such as vinyl, allyl and isopropenyl groups, are preferred.

Here, examples of the halogen atom include fluorine, chlorine, bromine and iodine atoms.

The alkyl groups of 1 to 5 carbon atoms may be ones having a linear, branched or cyclic structure. Illustrative examples include methyl, ethyl, n-propyl, isopropyl, n-butyl, sec-butyl, tert-butyl, n-pentyl and cyclohexyl groups.

Illustrative examples of aryl groups of 6 to 20 carbon atoms include phenyl, xylyl, tolyl, biphenyl and naphthyl groups.

Illustrative examples of aralkyl groups of 7 to 20 carbon atoms include benzyl, phenylethyl and phenylcyclohexyl groups.

Illustrative examples of the oxazoline monomer having a polymerizable carbon-carbon double bond-containing group at the 2 position shown in formula (12) include 2-vinyl-2-oxazoline, 2-vinyl-4-methyl-2-oxazoline, 2-vinyl-4-ethyl-2-oxazoline, 2-vinyl-4-propyl-2-oxazoline, 2-vinyl-4-butyl-2-oxazoline, 2-vinyl-5-methyl-2-oxazoline, 2-vinyl-5-ethyl-2-oxazoline, 2-vinyl-5-propyl-2-oxazoline, 2-vinyl-5-butyl-2-oxazoline, 2-isopropenyl-2-oxazoline, 2-isopropenyl-4-methyl-2-oxazoline, 2-isopropenyl-4-ethyl-2-oxazoline, 2-isopropenyl-4-propyl-2-oxazoline, 2-isopropenyl-4-butyl-2-oxazoline, 2-isopropenyl-5-methyl-2-oxazoline, 2-isopropenyl-5-ethyl-2-oxazoline, 2-isopropenyl-5-propyl-2-oxazoline and 2-isopropenyl-5-butyl-2-oxazoline. In terms of availability, 2-isopropenyl-2-oxazoline is preferred.

Also, when the conductive carbon material-containing coating liquid is prepared using an aqueous solvent, it is preferable for the oxazoline polymer also to be water-soluble.

Such a water-soluble oxazoline polymer may be a homopolymer of the oxazoline monomer of formula (12) above. However, to further increase the solubility in water, the polymer is preferably one obtained by the radical polymerization of at least two types of monomer: the above oxazoline monomer, and a hydrophilic functional group-containing (meth)acrylic ester monomer.

Illustrative examples of hydrophilic functional group-containing (meth)acrylic monomers include (meth)acrylic acid, 2-hydroxyethyl acrylate, methoxy polyethylene glycol acrylate, monoesters of acrylic acid with polyethylene glycol, 2-aminoethyl acrylate and salts thereof, 2-hydroxyethyl methacrylate, methoxy polyethylene glycol methacrylate, monoesters of methacrylic acid with polyethylene glycol, 2-aminoethyl methacrylate and salts thereof, sodium (meth)acrylate, ammonium (meth)acrylate, (meth)acrylonitrile, (meth)acrylamide, N-methylol (meth)acrylamide, N-(2-hydroxyethyl) (meth)acrylamide and sodium styrene sulfonate. These may be used singly, or two or more may be used in combination. Of these, methoxy polyethylene glycol (meth)acrylate and monoesters of (meth)acrylic acid with polyethylene glycol are preferred.

Concomitant use may be made of monomers other than the oxazoline monomer and the hydrophilic functional group-containing (meth)acrylic monomer, provided that doing so does not adversely affect the ability of the oxazoline polymer to disperse CNTs.

Illustrative examples of such other monomers include (meth)acrylic ester monomers such as methyl (meth)acrylate, ethyl (meth)acrylate, butyl (meth)acrylate, 2-ethylhexyl (meth)acrylate, stearyl (meth)acrylate, perfluoroethyl (meth)acrylate and phenyl (meth)acrylate; α-olefin monomers such as ethylene, propylene, butene and pentene; haloolefin monomers such as vinyl chloride, vinylidene chloride and vinyl fluoride; styrene monomers such as styrene and α-methylstyrene; vinyl carboxylate monomers such as vinyl acetate and vinyl propionate; and vinyl ether monomers such as methyl vinyl ether and ethyl vinyl ether. These may each be used singly, or two or more may be used in combination.

To further increase the CNT-dispersing ability of the resulting oxazoline polymer, the content of oxazoline monomer in the monomer ingredients used to prepare the oxazoline polymer employed in the invention is preferably at least 10 wt %, more preferably at least 20 wt %, and even more preferably at least 30 wt %. The upper limit in the content of the oxazoline monomer in the monomer ingredients is 100 wt %, in which case a homopolymer of the oxazoline monomer is obtained.

To further increase the water solubility of the resulting oxazoline polymer, the content of the hydrophilic functional group-containing (meth)acrylic monomer in the monomer ingredients is preferably at least 10 wt %, more preferably at least 20 wt %, and even more preferably at least 30 wt %.

As mentioned above, the content of other monomers in the monomer ingredients is in a range that does not affect the ability of the resulting oxazoline polymer to disperse CNTs. This content differs according to the type of monomer and thus cannot be strictly specified, but may be suitably set in a range of from 5 to 95 wt %, and preferably from 10 to 90 wt %.

The average molecular weight of the oxazoline polymer is not particularly limited, although the weight-average molecular weight is preferably from 1,000 to 2,000,000, and more preferably from 2,000 to 1,000,000.

The oxazoline polymer that may be used in this invention can be synthesized by a known radical polymerization of the above monomers or may be acquired as a commercial product. Illustrative examples of such commercial products include Epocros WS-300 (from Nippon Shokubai Co., Ltd.; solids concentration, 10 wt %; aqueous solution), Epocros WS-700 (Nippon Shokubai Co., Ltd.; solids concentration, 25 wt %; aqueous solution), Epocros WS-500 (Nippon Shokubai Co., Ltd.; solids concentration, 39 wt %; water/1-methoxy-2-propanol solution), Poly(2-ethyl-2-oxazoline) (Aldrich), Poly(2-ethyl-2-oxazoline) (Alfa Aesar) and Poly(2-ethyl-2-oxazoline) (VWR International, LLC).

When the oxazoline polymer is commercially available as a solution, the solution may be used directly as is or may be used after replacing the solvent with a target solvent.

In the present invention, the mixing ratio of CNTs and dispersant, expressed as a weight ratio, is preferably from about 1,000:1 to about 1:100.

The concentration of dispersant in the coating liquid is not particularly limited, provided that it is a concentration which enables the CNTs to disperse in the solvent. However, the concentration in the coating liquid is preferably set to from about 0.001 to about 30 wt %, and more preferably to from about 0.002 to about 20 wt %.

The concentration of CNTs in the coating liquid varies according to the coating weight of the thin film to be obtained and the required mechanical, electrical and thermal characteristics, and may be any concentration at which at least a portion of the CNTs individually disperse and the target thin film can be produced. The concentration of CNTs in the coating liquid is preferably set to from about 0.0001 to about 30 wt %, more preferably from about 0.001 to about 20 wt %, and even more preferably from about 0.001 to about 10 wt %.

The solvent used to prepare the coating liquid is not particularly limited. However, taking in account, for example, the viscosity of the coating liquid, the use of an aqueous solvent that includes water is preferred in this invention.

Solvents other than water are not particularly limited, so long as they are ones that have hitherto been used in preparing conductive compositions. Illustrative examples include the following organic solvents: ethers such as tetrahydrofuran (THF), diethyl ether and 1,2-dimethoxyethane (DME); halogenated hydrocarbons such as methylene chloride, chloroform and 1,2-dichloroethane; amides such as N,N-dimethylformamide (DMF), N,N-dimethylacetamide (DMAc) and N-methyl-2-pyrrolidone (NMP); ketones such as acetone, methyl ethyl ketone, methyl isobutyl ketone and cyclohexanone; alcohols such as methanol, ethanol, isopropanol and n-propanol; aliphatic hydrocarbons such as n-heptane, n-hexane and cyclohexane; aromatic hydrocarbons such as benzene, toluene, xylene and ethylbenzene; glycol ethers such as ethylene glycol monoethyl ether, ethylene glycol monobutyl ether and propylene glycol monomethyl ether, and glycols such as ethylene glycol and propylene glycol. These solvents may be used singly, or two or more may be used in admixture.

In particular, from the standpoint of being able to increase the proportion of CNTs that are individually dispersed, NMP, DMF, THF, methanol and isopropanol are especially preferred. These solvents may be used singly, or two or more may be used in admixture.

When intermittent coating is carried out, it is preferable to use a solvent having a viscosity at 25° C. of at least 1.5 cp, with a solvent having a viscosity of at least 20 cp being more preferred. Illustrative examples of such solvents include the following organic solvents: glycol ethers such as ethylene glycol monoethyl ether, ethylene glycol monobutyl ether and propylene glycol monomethyl ether, glycols such as ethylene glycol and propylene glycol; and long-chain alcohols such as cyclohexanol, hexanol and octanol. These solvents may be used singly, or two or more may be used in admixture. Of these, from the standpoint of viscosity, glycols such as ethylene glycol and propylene glycol are preferred. The above viscosity is a measured value obtained with a type E viscometer.

A polymer that serves as a matrix may be added to the coating liquid used in the present invention. Illustrative examples of matrix polymers include the following thermoplastic resins: fluoropolymers such as polyvinylidene fluoride (PVdF), polytetrafluoroethylene, tetrafluoroethylene-hexafluoropropylene copolymers, vinylidene fluoride-hexafluoropropylene copolymers (P(VDF-HFP)) and vinylidene fluoride-chlorotrifluoroethylene copolymers (P(VDF-CTFE)); polyolefin resins such as polyvinylpyrrolidone, ethylene-propylene-diene ternary copolymers, polyethylene (PE), polypropylene (PP), ethylene-vinyl acetate copolymers (EVA) and ethylene-ethyl acrylate copolymers (EEA); polystyrene resins such as polystyrene (PS), high-impact polystyrene (HIPS), acrylonitrile-styrene copolymers (AS), acrylonitrile-butadiene-styrene copolymers (ABS), methyl methacrylate-styrene copolymers (MS) and styrene-butadiene rubbers; polycarbonate resins, vinyl chloride resins, polyamide resins, polyimide resins, (meth)acrylic resins such as sodium polyacrylate and polymethyl methacrylate (PMMA), polyester resins such as polyethylene terephthalate (PET), polybutylene terephthalate, polyethylene naphthalate, polybutylene naphthalate, polylactic acid (PLA), poly-3-hydroxybutyric acid, polycaprolactone, polybutylene succinate and polyethylene succinate/adipate; polyphenylene ether resins, modified polyphenylene ether resins, polyacetal resins, polysulfone resins, polyphenylene sulfide resins, polyvinyl alcohol resins, polyglycolic acids, modified starches, cellulose acetate, carboxymethylcellulose, cellulose triacetate; chitin, chitosan and lignin; the following electrically conductive polymers: polyaniline and emeraldine base (the semi-oxidized form of polyaniline), polythiophene, polypyrrole, polyphenylene vinylene, polyphenylene and polyacetylene; and the following thermoset or photocurable resins: epoxy resins, urethane acrylate, phenolic resins, melamine resins, urea resins and alkyd resins. Because it is desirable to use water as the solvent in the conductive carbon material dispersion of the invention, the matrix polymer is preferably a water-soluble polymer such as sodium polyacrylate, carboxymethylcellulose sodium, water-soluble cellulose ether, sodium alginate, polyvinyl alcohol, polystyrene sulfonic acid or polyethylene glycol. Sodium polyacrylate and carboxymethylcellulose sodium are especially preferred.

The matrix polymer may be acquired as a commercial product. Illustrative examples of such commercial products include sodium polyacrylate (Wako Pure Chemical Industries Co., Ltd.; degree of polymerization, 2,700 to 7,500), carboxymethylcellulose sodium (Wako Pure Chemical Industries, Ltd.), sodium alginate (Kanto Chemical Co., Ltd.; extra pure reagent), the Metolose SH Series (hydroxypropylmethyl cellulose, from Shin-Etsu Chemical Co., Ltd.), the Metolose SE Series (hydroxyethylmethyl cellulose, from Shin-Etsu Chemical Co., Ltd.), JC-25 (a fully saponified polyvinyl alcohol, from Japan Vam & Poval Co., Ltd.), JM-17 (an intermediately saponified polyvinyl alcohol, from Japan Vain & Poval Co., Ltd.), JP-03 (a partially saponified polyvinyl alcohol, from Japan Vam & Poval Co., Ltd.) and polystyrenesulfonic acid (from Aldrich Co.; solids concentration, 18 wt %; aqueous solution).

The matrix polymer content, although not particularly limited, is preferably set to from about 0.0001 to about 99 wt %, and more preferably from about 0.001 to about 90 wt %, of the composition.

The coating liquid used in the invention may include a crosslinking agent that gives rise to a crosslinking reaction with the dispersant used, or a crosslinking agent that is self-crosslinking. These crosslinking agents preferably dissolve in the solvent that is used.

Crosslinking agents for triarylamine-based highly branched polymers are exemplified by melamine crosslinking agents, substituted urea crosslinking agents, and crosslinking agents which are polymers thereof. These crosslinking agents may be used singly, or two or more may be used in admixture. A crosslinking agent having at least two crosslink-forming substituents is preferred. Illustrative examples of such crosslinking agents include compounds such as CYMEL®, methoxymethylated glycoluril, butoxymethylated glycoluril, methylolated glycoluril, methoxymethylated melamine, butoxymethylated melamine, methylolated melamine, methoxymethylated benzoguanamine, butoxymethylated benzoguanamine, methylolated benzoguanamine, methoxymethylated urea, butoxymethylated urea, methylolated urea, methoxymethylated thiourea, methoxymethylated thiourea and methylolated thiourea, as well as condensates of these compounds.

Crosslinking agents for oxazoline polymers are not particularly limited, provided that they are compounds having two or more functional groups which react with oxazoline groups, such as carboxyl, hydroxyl, thiol, amino, sulfinic acid and epoxy groups. Compounds having two or more carboxyl groups are preferred. Compounds which have functional groups such as the sodium, potassium, lithium or ammonium salts of carboxylic acids that, under heating during thin-film formation or in the presence of an acid catalyst, generate the above functional groups and give rise to crosslinking reactions, may also be used as the crosslinking agent.

Examples of compounds which give rise to crosslinking reactions with oxazoline groups include the metal salts of synthetic polymers such as polyacrylic acid and copolymers thereof or of natural polymers such as carboxymethylcellulose or alginic acid which exhibit crosslink reactivity in the presence of an acid catalyst, and ammonium salts of these same synthetic polymers and natural polymers which exhibit crosslink reactivity under heating. Sodium polyacrylate, lithium polyacrylate, ammonium polyacrylate, carboxymethylcellulose sodium, carboxymethylcellulose lithium and carboxymethylcellulose ammonium, which exhibit crosslink reactivity in the presence of an acid catalyst or under heating conditions, are especially preferred.

These compounds that give rise to crosslinking reactions with oxazoline groups may be acquired as commercial products. Examples of such commercial products include sodium polyacrylate (Wako Pure Chemical Industries, Ltd.; degree of polymerization, 2,700 to 7,500), carboxymethylcellulose sodium (Wako Pure Chemical Industries, Ltd.), sodium alginate (Kanto Chemical Co., Ltd.; extra pure reagent), Aron A-30 (ammonium polyacrylate, from Toagosei Co., Ltd.; an aqueous solution having a solids concentration of 32 wt %), DN-800H (carboxymethylcellulose ammonium, from Daicel FineChem, Ltd.) and ammonium alginate (Kimica Corporation).

Examples of crosslinking agents that are self-crosslinking include compounds having, on the same molecule, crosslinkable functional groups which react with one another, such as a hydroxyl group with an aldehyde group, epoxy group, vinyl group, isocyanate group or alkoxy group; a carboxyl group with an aldehyde group, amino group, isocyanate group or epoxy group; or an amino group with an isocyanate group or aldehyde group; and compounds having like crosslinkable functional groups which react with one another, such as hydroxyl groups (dehydration condensation), mercapto groups (disulfide bonding), ester groups (Claisen condensation), silanol groups (dehydration condensation), vinyl groups and acrylic groups.

Specific examples of crosslinking agents that are self-crosslinking include any of the following which exhibit crosslink reactivity in the presence of an acid catalyst: polyfunctional acrylates, tetraalkoxysilanes, and block copolymers of a blocked isocyanate group-containing monomer and a monomer having at least one hydroxyl, carboxyl or amino group.

Such self-crosslinking compounds may be acquired as commercial products. Examples of commercial products include polyfunctional acrylates such as A-9300 (ethoxylated isocyanuric acid triacrylate, from Shin-Nakamura Chemical Co., Ltd.), A-GLY-9E (ethoxylated glycerine triacrylate (EO 9 mol), from Shin-Nakamura Chemical Co., Ltd.) and A-TMMT (pentaerythritol tetraacrylate, from Shin-Nakamura Chemical Co., Ltd.); tetraalkoxysilanes such as tetramethoxysilane (Tokyo Chemical Industry Co., Ltd.) and tetraethoxysilane (Toyoko Kagaku Co., Ltd.); and blocked isocyanate group-containing polymers such as the Elastron Series E-37, H-3, H38, BAP, NEW BAP-15, C-52, F-29, W-11P, MF-9 and MF-25K (DKS Co., Ltd.).

The amount in which these crosslinking agents is added varies according to, for example, the solvent used, the substrate used, the viscosity required and the film shape required, but is generally from 0.001 to 80 wt %, preferably from 0.01 to 50 wt %, and more preferably from 0.05 to 40 wt %, based on the dispersant. These crosslinking agents, although they sometimes give rise to crosslinking reactions due to self-condensation, induce crosslinking reactions with the dispersant. In cases where crosslinkable substituents are present in the dispersant, crosslinking reactions are promoted by these crosslinkable substituents.

In the present invention, the following may be added as catalysts for promoting the crosslinking reaction: acidic compounds such as p-toluenesulfonic acid, trifluoromethanesulfonic acid, pyridinium p-toluenesulfonic acid, salicylic acid, sulfosalicylic acid, citric acid, benzoic acid, hydroxybenzoic acid and naphthalenecarboxylic acid; and/or thermal acid generators such as 2,4,4,6-tetrabromocyclohexadienone, benzoin tosylate, 2-nitrobenzyl tosylate and alkyl esters of organic sulfonic acids.

The amount of catalyst added with respect to the dispersant is from 0.0001 to 20 wt %, preferably from 0.0005 to 10 wt %, and more preferably from 0.001 to 3 wt %.

A defoamer may be added to the coating liquid used in the present invention.

The defoamer is not particularly limited, although the use of one or more type selected from among acetylene-based surfactants, silicone-based surfactants, metal soap-based surfactants and acrylic-based surfactants is preferred. In particular, to suppress agglomeration of the conductive carbon material and ensure uniform dispersibility, defoamers that include an acetylene-based surfactant are desirable, a defoamer containing at least 50 wt % of an acetylene-based surfactant being preferred, a defoamer containing at least 80 wt % of an acetylene-based surfactant being more preferred, and a defoamer consisting solely of an acetylene-based surfactant (100 wt %) being most preferred.

The amount of defoamer used is not particularly limited. However, to both elicit a sufficient foam suppressing effect and also suppress agglomeration of the conductive carbon material and ensure its uniform dispersibility, the amount is preferably from 0.001 to 1.0 wt %, and more preferably from 0.01 to 0.5 wt %, of the overall coating liquid.

Acetylene-based surfactants that may be used as the defoamer in the present invention are not particularly limited, although preferred use can be made of surfactants containing ethoxylated acetylene glycols of formula (13) below.

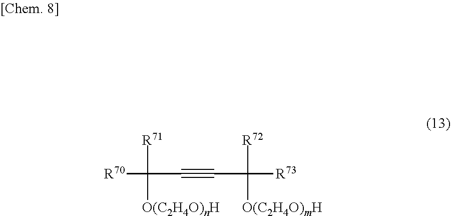

In formula (13), R⁷⁰ to R⁷³ are each independently an alkyl group of 1 to 10 carbon atoms and the subscripts n and m are each independently an integer of 0 or more, with the sum n+m being from 0 to 40.

The alkyl group of 1 to 10 carbon atoms, which may be linear, branched or cyclic, is exemplified by methyl, ethyl, n-propyl, isopropyl, n-butyl, sec-butyl, tert-butyl, n-pentyl, n-hexyl, n-heptyl, n-octyl n-nonyl and n-decyl groups.

Specific examples of the acetylene glycol of formula (13) above include 2,5,8,11-tetramethyl-6-dodecyn-5,8-diol, 58-dimethyl-6-dodecyn-5,8-diol, 2,4,7,9-tetramethyl-5-decyn-4,7-diol, 4,7-dimethyl-5-decyn-4,7-diol, 2,3,6,7-tetramethyl-4-octyn-3,6-diol, 3,6-dimethyl-4-octyn-3,6-diol, 2,5-dimethyl-3-hexyn-2,5-diol, an ethoxylate of 2,4,7,9-tetramethyl-5-decyn-4,7-diol having 1.3 moles of added ethylene oxide, an ethoxylate of 2,4,7,9-tetramethyl-5-decyn-4,7-diol having 4 moles of added ethylene oxide, an ethoxylate of 3,6-dimethyl-4-octyn-3,6-diol having 4 moles of added ethylene oxide, an ethoxylate of 2,5,8,11-tetramethyl-6-dodecyn-5,8-diol having 6 moles of added ethylene oxide, an ethoxylate of 2,4,7,9-tetramethyl-5-decyn-4,7-diol having 10 moles of added ethylene oxide, an ethoxylate of 2,4,7,9-tetramethyl-5-decyn-4,7-diol having 30 moles of added ethylene oxide, and an ethoxylate of 3,6-dimethyl-4-octyn-3,6-diol having 20 moles of added ethylene oxide. These may be used singly or two or more may be used in combination.

Acetylene-based surfactants that may be used in the present invention include those that are available as commercial products. Examples of such commercial products include Olfine D-10PG (from Nisshin Chemical Industry Co., Ltd.; active ingredient, 50 wt %; light-yellow liquid), Olfine E-1004 (Nisshin Chemical Industry Co., Ltd.; active ingredient, 100 wt %; light-yellow liquid), Olfine E-1010 (Nisshin Chemical Industry Co., Ltd.; active ingredient, 100 wt %; light-yellow liquid), Olfine E-1020 (Nisshin Chemical Industry Co., Ltd.; active ingredient, 100 wt %; light-yellow liquid), Olfine E-1030W (Nisshin Chemical Industry Co., Ltd.; active ingredient, 75 wt %; light-yellow liquid), Surfynol 420 (Nisshin Chemical Industry Co., Ltd.; active ingredient, 100 wt %; light-yellow viscous material), Surfynol 440 (Nisshin Chemical Industry Co., Ltd.; active ingredient, 100 wt %; light-yellow viscous material) and Surfynol 104E (Nisshin Chemical Industry Co., Ltd.; active ingredient, 50 wt %; light-yellow viscous material).

Silicone-based surfactants that may be used as the defoamer in the invention are not particularly limited. So long as they include at least a silicone chain, they may be linear, branched or cyclic, and moreover may include either a hydrophobic group or a hydrophilic group.

Examples of hydrophobic groups include alkyl groups such as methyl, ethyl, n-propyl, isopropyl, n-butyl, sec-butyl, tert-butyl, n-pentyl, n-hexyl, n-heptyl, n-octyl, n-nonyl and n-decyl groups; cyclic alkyl groups such as a cyclohexyl group; and aromatic hydrocarbon groups such as a phenyl group.

Examples of hydrophilic groups include amino, thiol, hydroxyl and alkoxy groups, carboxylic, sulfonic, phosphoric and nitric acids as well as organic salts and inorganic salts thereof, and ester groups, aldehyde groups, glycerol groups and heterocyclic groups.

Specific examples of silicone-based surfactants include dimethyl silicone, methyl phenyl silicone, chlorophenyl silicone, alkyl-modified silicones, fluorine-modified silicones, amino-modified silicones, alcohol-modified silicones, phenol-modified silicones, carboxy-modified silicones, epoxy-modified silicones, fatty acid ester-modified silicones and polyester-modified silicones.

Silicone-based surfactants that may be used in the invention include those that are available as commercial products. Examples of such commercial products include BYK-300, BYK-301, BYK-302, BYK-306, BYK-307, BYK-310, BYK-313, BYK-320, BYK-333, BYK-341, BYK-345, BYK-346, BYK-347, BYK-348 and BYK-349 (available under these trade names from BYK-Chemie Japan KK); KM-80, KF-351A, KF 352A, KF-353, KF-354L, KF-355A, KF-615A, KF-945, KF-640, KF-642, KF-643, KF-6020, X-22-4515, KF-6011, KF-6012, KF-6015 and KF-6017 (available under these trade names from Shin-Etsu Chemical Co., Ltd.); SH-28PA, SH8400, SH-190 and SF-8428 (available under these trade names from Dow Corning Toray Co., Ltd.); Polyflow KL-245, Polyflow KL-270 and Polyflow KL-100 (available under these trade names from Kyoeisha Chemical Co., Ltd.); and Silface SAG002, Silface SAG005 and Silface SAG0085 (available under these trade names from Nisshin Chemical Industry Co., Ltd.).

Metal soap-based surfactants that may be used as the defoamer in the present invention are not particularly limited, and may be metal soaps of a linear, branched or cyclic structure that include at least a polyvalent metallic ion such as calcium or magnesium.

Specific examples include salts of fatty acids of 12 to 22 carbon atoms and metals (alkaline earth metals, aluminum, manganese, cobalt, copper, iron, zinc, nickel, etc.), such as aluminum stearate, manganese stearate, cobalt stearate, copper stearate, iron stearate, nickel stearate, calcium stearate, zinc laurate and magnesium behenate.

Metal soap-based surfactants that may be used in the present invention include those available as commercial products. Such commercial products are exemplified by Nopco NXZ (available under this trade name from San Nopco, Ltd.).

Acrylic-based surfactants that may be used as the defoamer in the present invention are not particularly limited, provided that they are polymers which can be obtained by polymerizing at least an acrylic monomer, although polymers obtained by polymerizing at least an alkyl acrylate are preferred, and polymers obtained by polymerizing at least an alkyl acrylate in which the number of carbon atoms on the alkyl group is from 2 to 9 are more preferred.

Specific examples of alkyl acrylates in which the number of carbon atoms on the alkyl group is from 2 to 9 include ethyl acrylate, n-propyl acrylate, isopropyl acrylate, n-butyl acrylate, isobutyl acrylate, t-butyl acrylate, n-octyl acrylate, 2-ethylhexyl acrylate and isononyl acrylate.

Acrylic-based surfactants that may be used in the invention include those that are available as commercial products. Examples of such commercial products include 1970, 230, LF-1980, LF-1982(−50), LF-1983(−50), LF-1984(−50), LHP-95, LHP-96, UVX-35, UVX-36, UVX-270, UVX-271, UVX-272, AQ-7120 and AQ-7130 (available under these trade names from Kusumoto Chemicals, Ltd.); BYK-350, BYK-352, BYK-354, BYK-355, BYK-358, BYK-380, BYK-381 and BYK-392 (available under these trade names from BYK-Chemie Japan KK); Polyflow No. 7, Polyflow No. 50E, Polyflow No. 85, Polyflow No. 90, Polyflow No. 95, Flowlen AC-220F and Polyflow KL-800 (available under these trade names from Kyoeisha Chemical Co., Ltd.); and the Newcol series (available from Nippon Nyukazai Co., Ltd.).

The method of preparing the coating liquid used in the invention is not particularly limited, and may involve mixing together in any order the conductive carbon material and the solvent, and also the dispersant, matrix polymer, crosslinking agent and defoamer which may be used where necessary, so as to prepare a dispersion.

The mixture is preferably dispersion treated at this time. Such treatment enables the proportion of the conductive carbon material such as CNTs that is dispersed to be further increased. Examples of dispersion treatment include mechanical treatment in the form of wet treatment using, for example, a ball mill, bead mill or jet mill, or in the form of ultrasonic treatment using a bath-type or probe-type sonicator. Wet treatment using a jet mill and ultrasonic treatment are especially preferred.

The dispersion treatment may be carried out for any length of time, although a period of from about 1 minute to about 10 hours is preferred, and a period of from about 5 minutes to about 5 hours is even more preferred. If necessary, heat treatment may be carried out at this time.

When optional ingredients such as a matrix polymer are used, these may be added later to the mixture of the conductive carbon material and the solvent.

A thin film can be obtained by applying the above-described coating liquid onto at least one side of a substrate such as a current-collecting substrate using a gravure coater or a die coater, and then drying the applied coating liquid in air or under heating. This thin film, by being formed on a current-collecting substrate, can be suitably used as an undercoat layer in an energy storage device.

The coating speed when coating, although not particularly limited, is preferably from 1 to 150 m/min, more preferably from 2 to 100 m/min or more, even more preferably from 3 to 75 m/min or more, still more preferably from 3 to 50 m/min, and yet more preferably from 3 to 30 m/min.

The thickness of the thin film is not particularly limited. However, when used as an undercoat layer in an energy storage device, to reduce the internal resistance of the resulting device, the thickness is preferably from 1 nm to 10 μm, more preferably from 1 nm to 1 μm, and even more preferably from 1 to 500 nm.

The thickness of this thin film (undercoat layer) can be determined by, for example, cutting out a test specimen of a suitable size from a thin film-bearing substrate (undercoat foil), exposing the foil cross-section by such means as tearing the specimen by hand, and using a scanning electron microscope (SEM) or the like to microscopically examine the cross-sectional region where the thin layer (undercoat layer) lies exposed.

The coating weight of the thin film per side of the substrate is not particularly limited, so long as the above-indicated film thickness is satisfied, but is preferably not more than 1,000 mg/m², more preferably not more than 250 mg/m², even more preferably not more than 200 mg/m², still more preferably not more than 100 mg/m², and yet more preferably not more than 50 mg/m².

The coating weight has no particular lower limit. However, when the thin film is used as an undercoat layer, to ensure that the undercoat layer functions and to reproducibly obtain batteries having excellent characteristics, the coating weight of the undercoat layer per side of the current-collecting substrate is set to preferably at least 0.001 g/m², more preferably at least 0.005 g/m², even more preferably at least 0.01 g/m², and still more preferably at least 0.015 g/m².

The coating weight of the thin film is the ratio of the weight (g) of the thin film to the surface area (m²) of the thin film. In cases where the thin film is formed by intermittent coating in a regular pattern, this surface area is the surface area of only the coated regions and does not include the surface area of uncoated regions of the substrate.

The weight of the thin film can be determined by, for example, cutting out a test specimen of a suitable size from the thin film-bearing substrate (undercoat foil) and measuring its weight W0, subsequently stripping the thin film from the thin film-bearing substrate and measuring the weight W1 after the thin film has been removed, and calculating the difference therebetween (W0−W1). Alternatively, the weight of the thin film can be determined by first measuring the weight W2 of the substrate, subsequently measuring the weight W3 of the thin-film-bearing substrate, and calculating the difference therebetween (W3−W2).

The method used to strip off the thin film may involve, for example, immersing the thin film in a solvent which dissolves the thin film or causes it to swell, and then wiping off the thin film with a cloth or the like.

The coating weight and film thickness can be adjusted by a known method. For example, these properties can be adjusted by varying the solids concentration of the coating liquid, the number of coating passes or the clearance of the coating liquid delivery opening in the coater.

When one wishes to increase the coating weight or film thickness, this is done by making the solids concentration higher, increasing the number of coating passes or making the clearance larger. When one wishes to lower the coating weight or film thickness, this is done by making the solids concentration lower, reducing the number of coating passes or making the clearance smaller.

When the applied film is dried under applied heat after coating, although not particularly limited, the temperature is preferably from about 50° C. to about 200° C., and more preferably from about 80° C. to about 150° C.

When the thin film of the invention is used as an undercoat layer in an energy storage device, the current-collecting substrate serving as the substrate may be suitably selected from among ones which have hitherto been used as current-collecting substrates for energy storage device electrodes. For example, use can be made of thin films of copper, aluminum, nickel, gold, silver and alloys thereof, and of carbon materials, metal oxides and conductive polymers. In cases where the electrode assembly is produced by the application of welding such as ultrasonic welding, the use of metal foil made of copper, aluminum, nickel, gold, silver or an alloy thereof is preferred.

The thickness of the current-collecting substrate is not particularly limited, although a thickness of from 1 to 100 μm is preferred in this invention.

An electrode for an energy storage device can be produced by forming an active material layer on an undercoat layer that has been formed by the method of the invention on a current-collecting substrate.

The energy storage device is exemplified by various types of energy storage devices, including electrical double-layer capacitors, lithium secondary batteries, lithium-ion secondary batteries, proton polymer batteries, nickel-hydrogen batteries, aluminum solid capacitors, electrolytic capacitors and lead storage batteries. The undercoat foil of the invention is particularly well-suited for use in electrical double-layer capacitors and lithium-ion secondary batteries.

The active material used here may be any of the various types of active materials that have hitherto been used in energy storage device electrodes.

For example, in the case of lithium secondary batteries and lithium-ion secondary batteries, chalcogen compounds capable of intercalating and deintercalating lithium ions, lithium ion-containing chalcogen compounds, polyanion compounds, elemental sulfur and sulfur compounds may be used as the positive electrode active material.

Illustrative examples of such chalcogen compounds capable of intercalating and deintercalating lithium ions include FeS₂, TiS₂, MoS₂, V₂O₆, V₆O₁₃ and MnO₂.

Illustrative examples of lithium ion-containing chalcogen compounds include LiCoO₂, LiMnO₂, LiMn₂O₄, LiMo₂O₄, LiV₃O₈, LiNiO₂ and LiₓNi_{y}M_{1-y}O₂ (wherein M is one or more metal element selected from cobalt, manganese, titanium, chromium, vanadium, aluminum, tin, lead and zinc; and the conditions 0.05≤x≤1.10 and 0.5≤y≤1.0 are satisfied).

An example of a polyanion compound is LiFePO₄.

Illustrative examples of sulfur compounds include Li₂S and rubeanic acid.

The following may be used as the negative electrode active material making up the negative electrode: alkali metals, alkali alloys, at least one elemental substance selected from among group 4 to 15 elements of the periodic table which intercalate and deintercalate lithium ions, as well as oxides, sulfides and nitrides thereof, and carbon materials which are capable of reversibly intercalating and deintercalating lithium ions.

Illustrative examples of the alkali metals include lithium, sodium and potassium. Illustrative examples of the alkali metal alloys include Li—Al, Li—Mg, Li—Al—Ni, Na—Hg and Na—Zn.

Illustrative examples of the at least one elemental substance selected from among group 4 to 15 elements of the periodic table which intercalate and deintercalate lithium ions include silicon, tin, aluminum, zinc and arsenic.

Illustrative examples of the oxides include tin silicon oxide (SnSiO₃), lithium bismuth oxide (Li₃BiO₄), lithium zinc oxide (Li₂ZnO₂) and lithium titanium oxide (Li₄TisOi₂).

Illustrative examples of the sulfides include lithium iron sulfides (LiₓFeS₂ (0≤x≤3)) and lithium copper sulfides (LiₓCuS (O≤x≤3)).

Exemplary nitrides include lithium-containing transition metal nitrides, illustrative examples of which include LiₓM_{y}N (wherein M is cobalt, nickel or copper, 0≤x≤3, and 0≤y≤0.5) and lithium iron nitride (Li₃FeN₄).

Examples of carbon materials which are capable of reversibly intercalating and deintercalating lithium ions include graphite, carbon black, coke, glassy carbon, carbon fibers, carbon nanotubes, and sintered compacts of these.

In the case of electrical double-layer capacitors, a carbonaceous material may be used as the active material.

The carbonaceous material is exemplified by activated carbon, such as activated carbon obtained by carbonizing a phenolic resin and then subjecting the carbonized resin to activation treatment.

The active material layer may be formed by applying onto the undercoat layer an electrode slurry prepared by combining the above-described active material, the subsequently described binder polymer and, optionally, a solvent, and then drying in air or under heating.

A known material may be suitably selected and used as the binder polymer. Illustrative examples include electrically conductive polymers such as polyvinylidene fluoride (PVdF), polyvinylpyrrolidone, polytetrafluoroethylene, tetrafluoroethylene-hexafluoropropylene copolymers, vinylidene fluoride-hexafluoropropylene copolymers (P(VDF-HFP)), vinylidene fluoride-chlorotrifluoroethylene copolymers (P(VDF-CTFE)), polyvinyl alcohols, polyimides, ethylene-propylene-diene ternary copolymers, styrene-butadiene rubbers, carboxymethylcellulose (CMC), polyacrylic acid (PAA) and polyaniline.

The amount of binder polymer added per 100 parts by weight of the active material is preferably from 0.1 to 20 parts by weight, and more preferably from 1 to 10 parts by weight.

The solvent is exemplified by the solvents mentioned above for the conductive composition. The solvent may be suitably selected from among these according to the type of binder, although NMP is preferred in the case of water-insoluble binders such as PVdF, and water is preferred in the case of water-soluble binders such as PAA.

The electrode slurry may also contain a conductive additive. Illustrative examples of conductive additives include carbon black, ketjen black, acetylene black, carbon whiskers, carbon fibers, natural graphite, synthetic graphite, titanium oxide, ruthenium oxide, aluminum and nickel.

The method of applying the electrode slurry is exemplified by the same techniques as mentioned above for the conductive composition.

The temperature when drying under applied heat, although not particularly limited, is preferably from about 50° C. to about 400° C., and more preferably from about 80° C. to about 150° C.

If necessary, the electrode may be pressed. Any commonly used method may be employed for pressing, although mold pressing or roll pressing is especially preferred. The pressing force in roll pressing, although not particularly limited, is preferably from 0.2 to 3 metric ton/cm.

The energy storage device should have a structure which includes the above-described energy storage device electrode. More specifically, it is constructed of at least a pair of positive and negative electrodes, a separator between these electrodes, and an electrolyte, with at least the positive electrode or the negative electrode being the above-described energy storage device electrode.

This energy storage device is characterized by the use, as an electrode therein, of the above-described energy storage device electrode, and so the separator, electrolyte and other constituent members of the device that are used may be suitably selected from known materials.

Illustrative examples of the separator include cellulose-based separators and polyolefin-based separators.

The electrolyte may be either a liquid or a solid, and moreover may be either aqueous or non-aqueous, the energy storage device electrode of the invention being capable of exhibiting a performance sufficient for practical purposes even when employed in devices that use a non-aqueous electrolyte.

The non-aqueous electrolyte is exemplified by a non-aqueous electrolyte solution obtained by dissolving an electrolyte salt in a non-aqueous organic solvent.

Examples of the electrolyte salt include lithium salts such as lithium tetrafluoroborate, lithium hexafluorophosphate, lithium perchlorate and lithium trifluoromethanesulfonate; quaternary ammonium salts such as tetramethylammonium hexafluorophosphate, tetraethylammonium hexafluorophosphate, tetrapropylammonium hexafluorophosphate, methyltriethylammonium hexafluorophosphate, tetraethylammonium tetrafluoroborate and tetraethylammonium perchlorate; and lithium bis(trifluoromethanesulfonyl)imide and lithium bis(fluorosulfonyl)imide.

Examples of non-aqueous organic solvents include alkylene carbonates such as propylene carbonate, ethylene carbonate and butylene carbonate, dialkyl carbonates such as dimethyl carbonate, methyl ethyl carbonate and diethyl carbonate, nitriles such as acetonitrile, and amides such as dimethylformamide.

The configuration of the energy storage device is not particularly limited. Cells of various known configurations, such as cylindrical cells, flat wound prismatic cells, stacked prismatic cells, coin cells, flat wound laminate cells and stacked laminate cells may be used.

When used in a coil cell, the above-described energy storage device electrode may be die-cut in a specific disk shape and used.

For example, a lithium-ion secondary battery may be produced by setting one electrode on a coin cell cap to which a washer and a spacer have been welded, laying an electrolyte solution-impregnated separator of the same shape on top thereof, stacking the energy storage device electrode of the invention on top of the separator with the active material layer facing down, placing the coin cell case and a gasket thereon and sealing the cell with a coin cell crimper.

In a stacked laminate cell, use may be made of an electrode assembly obtained by welding a metal tab at, in an electrode where an active material layer has been formed on part or all of the undercoat layer surface, a region of the electrode where the active material layer is not formed (welding region). In cases where welding is carried out at a region where an undercoat layer is formed and an active material layer is not formed, the coating weight of the undercoat layer per side of the current-collecting substrate is set to preferably not more than 0.1 g/m², more preferably not more than 0.09 g/m², and even more preferably not more than 0.05 g/m².

The electrode making up the electrode assembly may be a single plate or a plurality of plates, although a plurality of plates are generally used in both the positive and negative electrodes.

The plurality of electrode plates used to form the positive electrode are preferably stacked in alternation one plate at a time with the plurality of electrode plates that are used to form the negative electrode. It is preferable at this time to interpose the above-described separator between the positive electrode and the negative electrode.

A metal tab may be welded at a welding region on the outermost electrode of the plurality of electrodes, or a metal tab may be sandwiched and welded between the welding regions on any two adjoining electrode plates.

The metal tab material is not particularly limited, provided it is one that is commonly used in energy storage devices. Examples include metals such as nickel, aluminum, titanium and copper, and alloys such as stainless steel, nickel alloys, aluminum alloys, titanium alloys and copper alloys. From the standpoint of welding efficiency, it is preferable for the tab material to include at least one metal selected from aluminum, copper and nickel.

The metal tab has a shape that is preferably in the form of foil, with the thickness being preferably from about 0.05 to about 1 mm.

Known methods for welding together metals may be used as the welding method. Examples include TIG welding, spot welding, laser welding and ultrasonic welding. It is preferable to join together the electrode and the metal tab by ultrasonic welding.

Ultrasonic welding methods are exemplified by a technique in which a plurality of electrodes are placed between an anvil and a horn, the metal tab is placed at the welding regions, and welding is carried out collectively by the application of ultrasonic energy, and a technique in which the electrodes are first welded together, following which the metal tab is welded.

In this invention, with either of these techniques, not only are the metal tab and the electrodes welded together at the welding regions, the plurality of electrodes are ultrasonically welded to one another.

The pressure, frequency, output power, treatment time, etc. during welding are not particularly limited, and may be suitably set while taking into account, for example, the presence or absence of an undercoat layer and the coating weight of the undercoat layer.

A laminate cell can be obtained by placing the electrode assembly produced as described above within a laminate pack, injecting the electrolyte solution described above, and subsequently heat sealing.

### EXAMPLES

Examples and Comparative Examples are given below to more fully illustrate the invention, although the invention is not limited by these Examples. Instruments and measurement conditions used in the Examples were as follows.

### (1) Gel Permeation Chromatography (GPC):

Instrument: HLC-8200 GPC (Tosoh Corporation)
Columns: Shodex KF-804L+KF-805L
Column temperature: 40° C.
Solvent: Tetrahydrofuran
Detector: UV (254 nm)
Calibration curve: Standard polystyrene

### (2) Gel Permeation Chromatography (GPC):

Instrument: HLC-8320 GPC EcoSEC (Tosoh Corporation)
Columns: TSKgel α-3000, TSKgel α-2500
Column temperature: 60° C.
Solvent: 1 wt % LiCl in NMP
Detector: UV (254 nm)
Calibration curve: Standard polystyrene

### (3) Type E Viscometer

Instrument: VISCOMETER TV-22 (Toki Sangyo Co., Ltd.)
Measurement temperature: 25° C.

### (4) Schottky Field Emission Scanning Electron Microscope

Instrument: JSM-7800F prime (JEOL, Ltd.)
Acceleration voltage during measurement: 1 kV
Magnification: 10,000

The starting materials used were as follows.
Triphenylamine: from Zhenjiang Haitong Chemical Industry Co., Ltd.
4-Phenylbenzaldehyde: from Mitsubishi Gas Chemical Co., Inc.
p-Toluenesulfonic acid monohydrate: from Meiyusangyo Co., Ltd.
1,4-Dioxane: from Junsei Chemical Co., Ltd.
Tetrahydrofuran: from Kanto Chemical Co., Inc.
Acetone: from Yamaichi Chemical Industries Co., Ltd.
28% Ammonia water: from Junsei Chemical Co., Ltd.
Sulfuric acid: from Junsei Chemical Co., Ltd.
IPA: 2-propanol, from Junsei Chemical Co., Ltd.
Multi-walled CNTs: NC7000, from Nanocyl S.A.
PG: Propylene glycol, from Junsei Chemical Co., Ltd.
Epocros WS-700: an oxazoline polymer-containing aqueous solution from Nippon Shokubai Co., Ltd.; solids concentration, 24.16 wt %; weight-average molecular weight, 4×10⁴; oxazoline group content, 4.5 mmol/g
Aron A-10H: a polyacrylic acid (PAA)-containing aqueous solution from Toagosei Co, Ltd.; solids concentration, 25.3 wt %
Aron A-30: an ammonium polyacrylate (PAA-NH₄)-containing aqueous solution from Toagosei Co., Ltd.; solids concentration, 31.6 wt %
Snow Algin: Sodium alginate from Kimica
Olfine E-1004: an acetylene-based defoamer from Nisshin Chemical Industry Co., Ltd.; solids concentration, 100 wt %
Kelzan: Xanthan gum from Fuji Chemical Industry Co., Ltd.

### [1] Synthesis of Dispersants

### [Synthesis Example 1] Synthesis of PTPA

Under nitrogen, a 10-liter four-neck flask was charged with 0.8 kg (3.26 mol) of triphenylamine, 1.19 kg of 4-phenylbenzaldehyde (2.0 eq. relative to the triphenylamine), 0.12 kg of p-toluenesulfonic acid monohydrate (0.2 eq. relative to the triphenylamine) and 1.6 kg of 1,4-dioxane (2 eq. relative to the triphenylamine). The temperature of this mixture was raised to 85° C. under stirring, thereby effecting dissolution and commencing polymerization. The reaction was carried out for 7.5 hours, after which the reaction mixture was allowed to cool to 60° C. and 5.6 kg of tetrahydrofuran (THF) was added. This reaction solution was added dropwise to a 50 L dropping tank charged with 20 kg of acetone, 0.8 kg of 28% ammonia water and 4 kg of pure water, thereby effecting reprecipitation. The precipitate that settled out was collected by filtration and then dried in vacuo at 80° C. for 21 hours. The solid thus obtained was re-dissolved by adding 8.0 kg of THF, and the resulting solution was added dropwise to a 30 L dropping tank charged with 20 kg of acetone and 4 kg of pure water, thereby effecting reprecipitation. The precipitate that settled out was collected by filtration and dried in vacuo at 80° C. for 24 hours, giving 1.18 kg of the highly branched polymer PTPA having recurring units of formula [A] below.

The weight-average molecular weight Mw of the resulting PTPA, as measured by gel permeation chromatography (GPC) against a polystyrene standard, was 73,600, and the polydispersity Mw/Mn was 10.0 (here, Mn represents the number-average molecular weight measured under the same conditions). The HLC-8200 GPC from Tosoh Corporation was used in this GPC measurement.

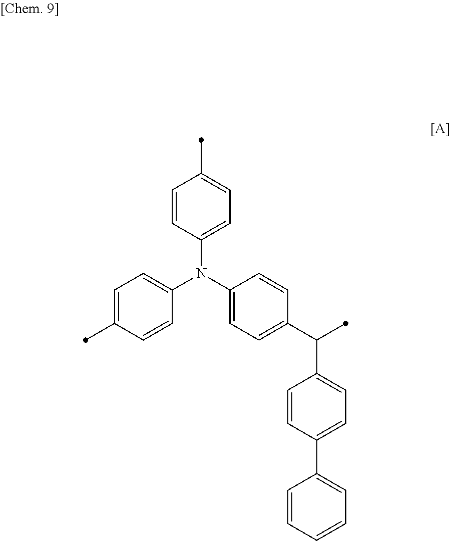

### [Synthesis Example 2] Synthesis of PTPA-S

Under nitrogen, a 2-liter four-neck flask was charged with 2.5 kg of sulfuric acid and 0.25 kg of the PTPA obtained in Synthesis Example 1. The temperature of this mixture was raised to 40° C. under stirring, thereby effecting dissolution and commencing sulfonation, and the reaction was carried out for 3 hours. This reaction mixture was poured into a 30 L dropping tank charged with 12.5 kg of pure water, thereby effecting reprecipitation. Stirring was carried out for 15 hours and the precipitate was collected by filtration, following which it was rinsed by spraying with 2.5 kg of pure water. The precipitate was then poured into 5.0 kg of pure water and stirred for 15 hours, after which the precipitate was collected by filtration and then rinsed by spraying with 2.5 kg of pure water. The precipitate was then dried in vacuo at 80° C. for 34 hours, giving 254 g of the highly branched polymer PTPA-S having recurring units of formula [B] below as a violet powder.

The weight-average molecular weight Mw of the resulting PTPA-S, as measured by gel permeation chromatography against a polystyrene standard, was 67,700, and the polydispersity Mw/Mn was 9.1 (here, Mn represents the number-average molecular weight measured under the same conditions). The HLC-8320 GPC EcoSEC from Tosoh Corporation was used in this GPC measurement.

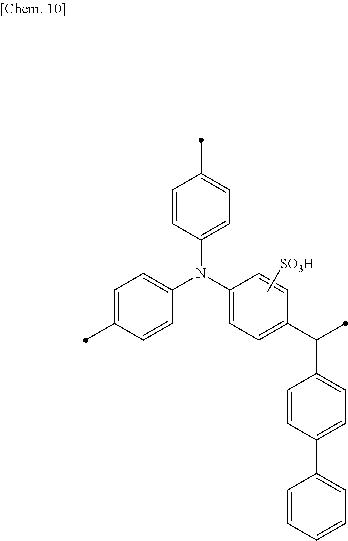

### [2] Preparation of Dispersion

### [Preparation Example 1] Preparation of CT-121M Dispersion

PTPA-S(152 g), 1,984 g of pure water and 10,912 g of IPA (from Junsei Chemical Co., Ltd.) were mixed together, and 152 g of multi-walled CNTs (NC7000, from Nanocyl S.A.) was additionally mixed therein.

The JN-1000 wet jet mill from Jokoh was washed with a mixed solvent of IPA/water=5.5/1 (weight ratio), after which the above mixture was subjected to dispersion treatment at 80 MPa (10 passes), thereby preparing the uniform dispersion CT-121M.

### [Preparation Example 2] Preparation of BD-120 Dispersion

PTPA-S (100 g), 880 g of pure water and 7,920 g of PG were mixed together, and 100 g of multi-walled CNTs was additionally mixed therein.

The JN-1000 wet jet mill from Jokoh was washed with a mixed solvent of PG/pure water=9/1 (weight ratio), after which the above mixture was subjected to dispersion treatment at 30 MPa (10 passes) and at 70 MPa (10 passes), thereby preparing the uniform dispersion BD-120.

### [Preparation Example 3] Preparation of BD-230 Dispersion

Epocros WS-700 (1,656 g) and 35,944 g of pure water were mixed together, and 400 g of multi-walled CNTs was additionally mixed therein.

The JN-1000 wet jet mill from Jokoh was washed with pure water, after which the above mixture was subjected to dispersion treatment at 45 MPa (3 passes) and at 90 MPa (10 passes), thereby preparing the uniform dispersion BD-230.

### [3] Preparation of Coating Liquid

### [Preparation Example 4] Preparation of BD-111 Using CT-121M Dispersion

The following were mixed together: 395 g of a polyacrylic acid (PAA)-containing aqueous solution (Aron A-10H; solids concentration, 25.3 wt %) and 4,605 g of IPA. The resulting solution was mixed with 5,000 g of CT-121M, thereby preparing uniform coating liquid BD-111. The resulting BD-111 had a viscosity, as measured with a type E viscometer, of 9.83 cp (25° C.).

### [Preparation Example 5] Preparation of 4-Fold Dilution of BD-111

A 4-fold dilution of the uniform coating liquid BD-111 was prepared by mixing 7,500 g of IPA into 2,500 g of BD-111. The resulting 4-fold dilution of BD-111 had a viscosity, as measured with a type E viscometer, of 3.50 cp (25° C.).

### [Preparation Example 6] Preparation of BD-121 Using BD-120 Dispersion

The following were mixed together: 462 g of a polyacrylic acid (PAA)-containing aqueous solution (Aron A-10H; solids concentration, 26 wt %) and 5,538 g of PG. The resulting solution was mixed with 6,000 g of BD-120, thereby preparing uniform coating liquid BD-121. The resulting BD-121 had a viscosity, as measured with a type E viscometer, of 163 cp (25° C.).

### [Preparation Example 7] Preparation of 1.2-Fold Dilution of BD-121

IPA (1,280 g) and 334 g of pure water were added to 8,386 g of BD-121. The resulting IPA/water-diluted BD-121 had a viscosity, as measured with a type E viscometer, of 61 cp (25° C.).

### [Preparation Example 8] Preparation of BD-231 Using BD-230 Dispersion

The following were mixed together: 139.24 g of an ammonium polyacrylate (PAA-NH₄)-containing aqueous solution (Aron A-30; solids concentration, 31.6 wt %), 4,000 g of a 1 wt % aqueous solution of Snow Algin (sodium alginate) and 5,861 g of pure water. The resulting solution was mixed with 10,000 g of BD-230, thereby preparing uniform coating liquid BD-231. The resulting BD-231 had a viscosity, as measured with a type E viscometer, of 17.1 cp (25° C.).

### [Preparation Example 9] Preparation of 1.5-Fold Dilution of BD-231

Pure water (2,500 g) was mixed into 5,000 g of BD-231, thereby preparing a 1.5-fold dilution of uniform coating liquid BD-231. The resulting 1.5-fold dilution of uniform coating liquid BD-231 had a viscosity, as measured with a type E viscometer, of 10.54 cp (25° C.).

### [Preparation Example 10] Preparation of Defoamer-Containing BD-231

The acetylene-based defoamer Olfine E-1004 (3.75 g) was mixed into 7,500 g of BD-231, thereby preparing uniform coating liquid BD-231. The resulting liquid BD-231 had a viscosity, as measured with a type E viscometer, of 18.19 cp (25° C.).

### [Preparation Example 11] Preparation of BD-242 Using BD-230 Dispersion

The following were mixed together: 63.29 g of an ammonium polyacrylate (PAA-NH₄)-containing aqueous solution (Aron A-30; solids concentration, 31.6 wt %), 2,000 g of a 0.25 wt % aqueous solution of Kelzan (xanthan gum), 5 g of Olfine E-1004, 4 g of Epocros WS-700 and 2,928 g of pure water. The resulting solution was mixed with 5,000 g of BD-230, thereby preparing uniform coating liquid BD-242. The resulting BD-242 had a viscosity, as measured with a type E viscometer, of 18.6 cp (25° C.).

### [4] Production of Undercoat Foil

### Examples 1 to 15

Undercoat foils in each Example were produced by applying the coating liquids obtained in Preparation Examples 4 to 11 onto aluminum foil (thickness, 15 μm) or copper foil (thickness, 15 μm) as the current-collecting substrate using the coating apparatus and under the coating conditions shown in Table 1 below, and then drying to form an undercoat layer.

The resulting undercoat foil was cut out to a surface area of 120 cm² and the weight was measured, following which the undercoat layer was removed by being rubbed and washed away with a dilute (0.1 mol/L) aqueous solution of hydrochloric acid. The weight of the remaining current-collecting substrate was measured, and the coating weight of the undercoat layer was determined by dividing the change in weight before and after removal of the undercoat layer by the surface area. The results are shown in Table 1.

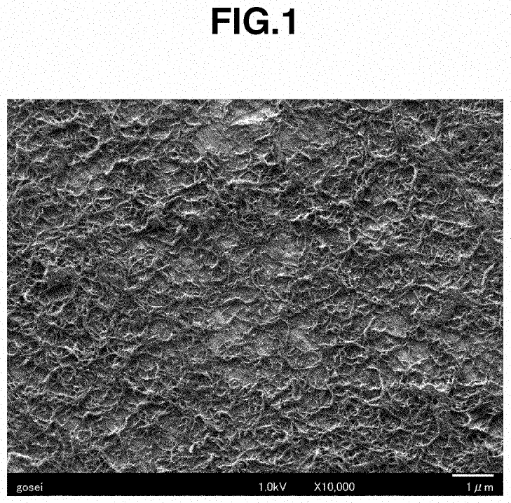

The condition of the undercoat layer that was formed in the undercoat foil produced in Example 14 was examined with an electron microscope. The result is shown in FIG. 1.

The coaters used were either a gravure coater (Fuji Kikai Kogyo Co., Ltd.) or a microgravure coater (Yasui Seiki Inc.).

TABLE 1

| | | Coater, | | | | Engraved pattern | | | | |
|---|---|---|---|---|---|---|---|---|---|---|
| | | Coating method, | | | | and | | | | |
| | | Gravure roller | | Solids | Current- | number of | Engraved pattern | Coating | Drying | Coating |
| | | direction | Coating | content | collecting | engraved lines | on | speed | temperature, | weight |
| | | of rotation | liquid | (wt %) | substrate | on gravure roller | gravure roller | (m/min) | drying time | (g/m²) |
| Example | 1 | Fuji | BD-111 | 2.0 | aluminum | honeycomb | for continuous | 5 | 110° C., | 207 |
| | | Kikai Kogyo | | | foil | 50 cells/inch | coating | | 96 sec | |
| | 2 | gravure coater, | BD-111 | 2.0 | aluminum | honeycomb | for continuous | 200 | 110° C., | 12 |
| | | kiss touch | | | foil | 400 cells/inch | coating | | 2.4 sec | |
| | | method, | | | | | | | | |
| | | reverse | | | | | | | | |
| | | direction | | | | | | | | |
| | | of rotation | | | | | | | | |
| | 3 | Fuji | 4-fold | 0.5 | aluminum | diagonal lines | for continuous | 20 | 110° C., | 31 |
| | | Kikai Kogyo | dilution of | | foil | 200 cells/inch | coating | | 24 sec | |
| | | gravure coater, | BD-111 | | | | | | | |
| | 4 | direct gravure | BD-121 | 2.0 | copper | diagonal lines | for continuous | 100 | 110° C., | 135 |
| | | method, | | | foil | 200 cells/inch | coating | | 4.8 sec | |
| | 5 | forward | 1.2-fold | 1.7 | copper | diagonal lines | for continuous | 5 | 110° C., | 199 |
| | | direction | dilution of | | foil | 200 cells/inch | coating and for | | 96 sec | |
| | | of rotation | BD-121 | | | | intermittent | | | |
| | | | | | | | coating (two | | | |
| | | | | | | | types on a single | | | |
| | | | | | | | gravure roller) | | | |
| | 6 | | 1.2-fold | 1.7 | copper | diagonal lines | for continuous | 20 | 110° C., | 193 |
| | | | dilution of | | foil | 200 cells/inch | coating and for | | 24 sec | |
| | | | BD-121 | | | | intermittent | | | |
| | | | | | | | coating (two | | | |
| | | | | | | | types on a single | | | |
| | | | | | | | gravure roller) | | | |
| | 7 | | 1.2-fold | 1.7 | copper | diagonal lines | for continuous | 50 | 110° C., | 158 |
| | | | dilution of | | foil | 200 cells/inch | coating and for | | 9.6 sec | |
| | | | BD-121 | | | | intermittent | | | |
| | | | | | | | coating (two | | | |
| | | | | | | | types on a single | | | |
| | | | | | | | gravure roller) | | | |
| | 8 | | 1.2-fold | 1.7 | copper | diagonal lines | for continuous | 100 | 110° C., | 134 |
| | | | dilution of | | foil | 200 cells/inch | coating and for | | 4.8 sec | |
| | | | BD-121 | | | | intermittent | | | |
| | | | | | | | coating (two | | | |
| | | | | | | | types on a single | | | |
| | | | | | | | gravure roller) | | | |
| | 9 | Fuji | 1.2-fold | 1.7 | copper | diagonal lines | for continuous | 5 | 110° C., | 222 |
| | | Kikai Kogyo | dilution of | | foil | 200 cells/inch | coating | | 96 sec | |
| | | gravure coater, | BD-121 | | | | | | | |
| | 10 | direct gravure | 1.2-fold | 1.7 | copper | diagonal lines | for continuous | 100 | 110° C., | 45 |
| | | method, | dilution of | | foil | 200 cells/inch | coating | | 4.8 sec | |
| | | reverse | BD-121 | | | | | | | |
| | | direction | | | | | | | | |
| | | of rotation | | | | | | | | |
| | 11 | Yasui Seiki | BD-231 | 1.4 | aluminum | diagonal lines | for continuous | 15 | 80° C./5.6 sec + | 171 |
| | | microgravure | | | foil | 150 cells/inch | coating | | 100° C./5.6 sec + | |
| | | coater, | | | | | | | 150° C./15.2 sec | |
| | 12 | kiss touch | 1.5-fold | 0.9 | aluminum | diagonal lines | for continuous | 3 | 80° C./28 sec + | 27 |
| | | method, | dilution of | | foil | 250 cells/inch | coating | | 100° C./28 sec + | |
| | | reverse | BD-231 | | | | | | 150° C./76 sec | |
| | 13 | direction | BD-242 | 1.3 | aluminum | diagonal lines | for continuous | 3 | | 44 |
| | | of rotation | | | foil | 230 cells/inch | coating | | | |
| | 14 | Fuji | Defoamer- | 1.5 | aluminum | diagonal lines | for continuous | 5 | 110° C., | 74 |
| | | Kikai Kogyo | containing | | foil | 150 cells/inch | coating | | 96 sec | |
| | | gravure coater, | BD-231 | | | | | | | |
| | 15 | kiss touch | Defoamer- | 1.5 | aluminum | honeycomb | for continuous | 5 | 110° C., | 82 |
| | | method, | containing | | foil | 50 cells/inch | coating | | 96 sec | |
| | | reverse | BD-231 | | | | | | | |
| | | direction | | | | | | | | |
| | | of rotation | | | | | | | | |

As shown in Table 1 and FIG. 1, by using the coating liquids of the invention, undercoat layers in which CNTs have been uniformly applied at a low coating weight can be produced with a gravure coater.

1. A method for producing a conductive carbon material-containing thin film, comprising the step of applying a conductive carbon material-containing coating liquid using a gravure coater or a die coater.

2. The conductive carbon material-containing thin film-producing method of claim 1, wherein the thin film has a coating weight of not more than 1,000 mg/m².

3. The conductive carbon material-containing thin film-producing method of claim 2, wherein the thin film has a coating weight of not more than 250 mg/m².

4. The conductive carbon material-containing thin film-producing method of any one of claims 1 to 3, wherein the conductive carbon material is carbon nanotubes.

5. The conductive carbon material-containing thin film-producing method of claim 1, wherein the conductive carbon material-containing coating liquid has a solids concentration of not more than 40.0 wt %.

6. The conductive carbon material-containing thin film-producing method of claim 5, wherein the conductive carbon material-containing coating liquid has a solids concentration of not more than 20.0 wt %.

7. The conductive carbon material-containing thin film-producing method of claim 6, wherein the conductive carbon material-containing coating liquid has a solids concentration of not more than 10.0 wt %.

8. The conductive carbon material-containing thin film-producing method of claim 7, wherein the conductive carbon material-containing coating liquid has a solids concentration of not more than 5.0 wt %.

9. The conductive carbon material-containing thin film-producing method of claim 8, wherein the conductive carbon material-containing coating liquid has a solids concentration of not more than 2.0 wt %.

10. The conductive carbon material-containing thin film-producing method of claim 1, wherein application is carried out using a gravure coater.

11. The conductive carbon material-containing thin film-producing method of claim 1, wherein the conductive carbon material-containing coating liquid comprises a dispersant which is a triarylamine-based highly branched polymer or a pendant oxazoline group-containing vinyl polymer.

12. The conductive carbon material-containing thin film-producing method of claim 1, wherein the conductive carbon material-containing thin film is an undercoat layer for an energy storage device electrode.
